(19) United States
(12) Patent Application Publication
(10) Pub. No.: US 2014/0215824 A1
(43) Pub. Date: Aug. 7, 2014

(54) SYSTEMS AND METHODS FOR SOLAR BOILER CONSTRUCTION

(71) Applicant: BABCOCK POWER SERVICES, INC., Worcester, MA (US)

(72) Inventors: Russell Ricci, Brookfield, MA (US); Andrew Plotkin, Worcester, MA (US)

(73) Assignee: BABCOCK POWER SERVICES, INC., Worcester, MA (US)

(21) Appl. No.: 14/250,053

(22) Filed: Apr. 10, 2014

Related U.S. Application Data
(62) Division of application No. 13/024,193, filed on Feb. 9, 2011.

(51) Int. Cl. B23P 15/26

(52) U.S. Cl. CPC B23P 15/26
USPC 29/890.033

(57) ABSTRACT

A solar boiler includes a plurality of solar boiler panels forming a perimeter surrounding a boiler interior space. A support structure within the boiler interior space supports the solar boiler panels. A steam/water vessel, such as a steam drum, is mounted to the support structure within the boiler interior space. A method of constructing a solar boiler includes raising a steam/water vessel, such as a steam drum, through a leave-out area in a boiler support structure. The method also includes mounting the steam/water vessel within the boiler support structure below an upper extent of the boiler support structure.

### CROSS-REFERENCE TO RELATED APPLICATIONS

This application is a divisional application of U.S. patent application Ser. No. 13/024,193, filed on Feb. 9, 2011, the contents of which are incorporated by reference herein in their entirety.

### BACKGROUND OF THE INVENTION

1. Field of the Invention

The present invention relates to solar power production, and more particularly to boilers for solar power production.

2. Description of Related Art

Solar power generation has been considered a viable source to help provide for energy needs in a time of increasing consciousness of the environmental aspects of power production. Solar energy production relies mainly on the ability to collect and convert energy freely available from the sun and can be produced with very little impact on the environment. Solar power can be produced without creating radioactive waste as in nuclear power production, and without producing pollutant emissions including greenhouse gases as in fossil fuel power production. Solar power production is independent of fluctuating fuel costs and does not consume non-renewable resources.

Solar power generators generally employ fields of controlled mirrors, called heliostats, to gather and concentrate sunlight on a receiver to provide a heat source for power production. A solar receiver typically takes the form of a panel of tubes conveying a working fluid therethrough. Previous solar generators have used working fluids such as molten salt because it has the ability to store energy, allowing power generation when there is little or no solar radiation, such as at night time. The heated working fluids are typically conveyed to a heat exchanger where they release heat into a second working fluid such as air, water, or steam. Power is generated by driving heated air or steam through a turbine that drives an electrical generator.

More recently, it has been determined that solar production can be increased and simplified by using water/steam as the only working fluid in a receiver that is a boiler. This can eliminate the need for an inefficient heat exchanger between two different working fluids. This development has lead to new challenges in handling the intense solar heat without damage to the system. Approaches to address many of these thermal management problems are provided, for example, in commonly owned, co-pending U.S. patent application Ser. No. 12/620,109, filed Nov. 17, 2009; Ser. No. 12/701,999, filed Feb. 8, 2010; Ser. No. 12/703,861, filed Feb. 11, 2010; and Ser. No. 12/850,862, filed Aug. 5, 2010, each of which is incorporated by reference herein in its entirety.

Additional challenges for solar boilers using water/steam as the working fluid involve construction of the boiler, which typically takes place at the top of a solar receiver tower. Of particular concern is lifting and mounting the steam drum in place. The drum is essentially at the heart of a boiler as it is used to separate saturated steam and liquid water, and traditionally connects the steam generator and superheater. The drum is the most massive single component in typical boilers.

Conventional wisdom dictates that steam drums be placed on top of boilers, since drums need to be at a higher elevation than the respective steam generating walls. Traditional solar boiler designs have followed this conventional wisdom, placing the drum on top of the boiler. Since solar boilers using heliostats are typically situated on top of a tower, which can be several times taller than the boiler itself, heretofore, the size of solar boilers has been limited at least in part due to the difficulty of raising a large steam drum to the top of a tall boiler tower. Power production capacity can generally be increased by increasing the size of the heliostat field, increasing the height of the receiver tower, and increasing the size of the boiler. Thus for high capacity power production, a solar receiver tower might need to be hundreds of feet tall. Overall boiler size, and by extension, power production capacity, has traditionally been limited by the size of the steam drum, which must be small enough for traditional cranes to safely lift over the boiler tower. Moreover, positioning a massive component like a steam drum onto the top of a solar boiler results in a high center of gravity for the whole receiver structure. This presents problems in terms of overall structural stability under earthquake and wind loading conditions.

Such conventional methods and systems have generally been considered satisfactory for their intended purpose. However, there is still a need in the art for systems and methods that allow for improved solar boiler construction, particularly with respect to installation of steam drums. There also remains a need for systems and methods that will allow for increased solar boiler size, and/or increased solar boiler structural integrity. The present invention provides a solution for these problems.

### SUMMARY OF THE INVENTION

The subject invention is directed to a new and useful solar boiler. The solar boiler includes a plurality of solar boiler panels forming a perimeter surrounding a boiler interior space. A support structure within the boiler interior space supports the solar boiler panels. A steam/water vessel, such as a steam drum, is mounted to the support structure within the boiler interior space.

In certain embodiments, the solar boiler panels define upper and lower extents of the boiler interior space, and the steam/water vessel is mounted below the upper extent of the boiler interior space. The solar boiler panels can form a substantially contiguous heat transfer surface configured to block solar radiation incident thereon from the boiler interior space. The solar boiler panels can form four boiler walls surrounding the boiler interior space. Any other suitable number of walls can be used without departing from the spirit and scope of the invention.

In accordance with certain embodiments, the support structure includes vertical load bearing supports arranged around a leave-out area dimensioned to allow passage of the steam/water vessel therethrough. The leave-out area can be devoid of vertical load bearing supports to accommodate passage of the steam/water vessel therethrough during construction of the solar boiler. The leave-out area can extend upwards from an area proximate a base of the support structure to an area in which the steam/water vessel is mounted.

It is contemplated that in certain embodiments secondary support structure can be included in the leave-out area below the steam/water vessel. At least one feedwater distribution pipe can extend through the leave-out area from a pumping section to the steam/water vessel. At least one feedwater distribution pipe can be mounted to the secondary support structure. The steam/water vessel can include drum internals (chevrons, steam separators), a chemical feed line, a blowdown line, downcomers, and/or feedwater distribution pipes.

The invention also provides a method of constructing a solar boiler. The method includes raising a steam/water vessel through a leave-out area in a boiler support structure. The method also includes mounting the steam/water vessel within the boiler support structure below an upper extent of the boiler support structure.

In accordance with certain embodiments, the step of mounting the steam/water vessel within the boiler includes suspending the boiler within the support structure with straps. Piping can be installed above the steam/water vessel, and piping to be located above the steam/water vessel can be installed prior to the step of raising the steam/water vessel into place. Secondary support structure can be installed in the leave-out area below the steam/water vessel. Piping can be mounted below the steam/water vessel to the secondary support structure in the leave-out area.

In accordance with certain embodiments, the method of constructing a solar boiler can include a step of installing insulation and lagging on the steam/water vessel. A step can be included for mounting a plurality of solar boiler panels to the support structure to form an exterior heat transfer surface substantially surrounding a boiler interior space, wherein the solar boiler panels are in fluid communication with the steam/water vessel, and wherein the exterior heat transfer surface has an upper extent above the steam/water vessel to shield the steam/water vessel and boiler interior space from concentrated solar radiation.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a front elevation view of an exemplary embodiment of a solar boiler constructed in accordance with the present invention, showing the solar boiler atop a solar receiver tower, with a cut-away portion showing the steam drum within the interior boiler space;

FIG. 2 is a front elevation view of the solar boiler of FIG. 1 during construction, showing the boiler support structure during a stage of construction prior to mounting the drum into place;

FIG. 3a is a schematic plan view of the solar boiler of FIG. 2, showing the leave-out area through which the drum is raised during construction;

FIG. 3b is a schematic plan view of the solar boiler of FIG. 3a, showing the leave-out area with structures placed therein after the drum is raised during construction;

FIG. 4 is a front elevation view of the solar boiler of FIG. 2, showing the drum being raised through the leave-out area during construction;

FIG. 5 is a front elevation view of the solar boiler of FIG. 2, showing the drum mounted in place within the solar boiler interior space;

FIG. 6 is a front elevation view of the solar boiler of FIG. 2, showing boiler components installed in the leave-out area at a stage of construction after the drum is mounted in place; and

FIG. 7 is a front elevation view of the solar boiler of FIG. 2, showing a stage of construction after the boiler is mounted in place, with boiler panels being assembled to the exterior of the boiler.

### DETAILED DESCRIPTION OF THE PREFERRED EMBODIMENTS

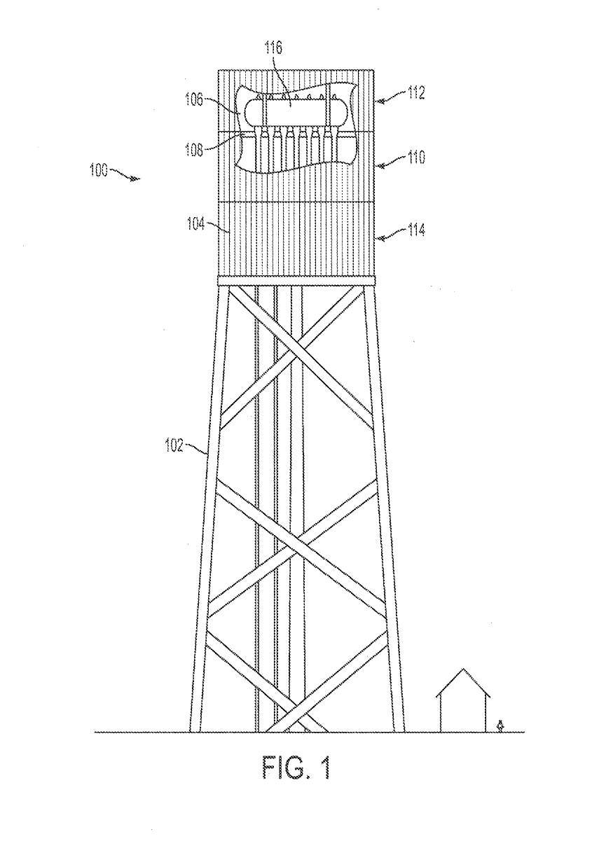

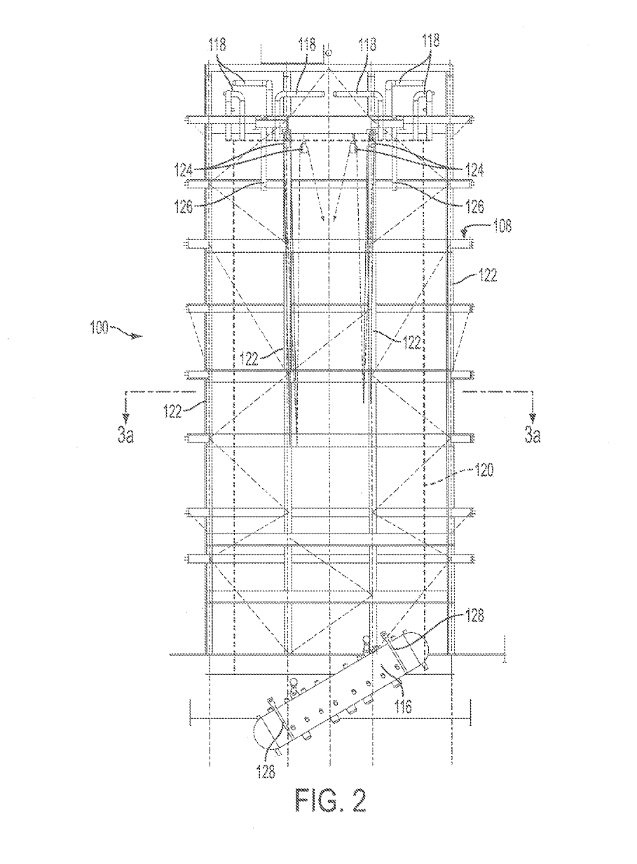

Reference will now be made to the drawings wherein like reference numerals identify similar structural features or aspects of the subject invention. For purposes of explanation and illustration, and not limitation, a partial view of an exemplary embodiment of a solar boiler constructed in accordance with the invention is shown in FIG. 1 and is designated generally by reference character 100. Other embodiments of solar boilers in accordance with the invention, or aspects thereof, are provided in FIGS. 2-7, as will be described. The systems and methods of the invention can be used to provide solar boilers with improved steam drum construction and placement.

With reference now to FIG. 1, solar boiler 100 is shown at the top of a solar receiver tower 102, which can be surrounded by a field of heliostats for focusing solar radiation on solar boiler 100. Solar boiler 100 includes a plurality of solar boiler panels 104 forming a perimeter surrounding a boiler interior space 106, which is visible through the cut-away portion in FIG. 1. A support structure 108 within boiler interior space 106 supports solar boiler panels 104. Boiler panels 104 include a steam generator 110 with a superheater 112 contiguous therewith on top of boiler 100, and with a reheater 114 contiguous with steam generator 110 on the bottom of boiler 100. Panels 104 for steam generator 110, superheater 112, and reheater 114 are described in commonly owned, co-pending U.S. patent application Ser. No. 12/552,724, filed Sep. 2, 2009, which is incorporated by reference herein in its entirety.

As can be seen in the cut-away portion of FIG. 1, a steam drum 116 is mounted to support structure 108 within boiler interior space 106. Boiler panels 104 define upper and lower extents of boiler interior space 106, and drum 116 is mounted below the upper extent of boiler interior space 106. More particularly, drum 116 is mounted in interior space 106 within the elevation of superheater 112, and even more particularly, drum 116 is mounted just below being centered between the top and bottom of superheater 112. Since boiler panels 104 form a substantially contiguous heat transfer surface configured to block solar radiation incident thereon from boiler interior space 106, drum 116 is protected from the intense thermal radiation incident on the solar receiver during operation. Solar boiler panels 104 can form four boiler walls surrounding boiler interior space 106. Any other suitable number of walls can be used without departing from the spirit and scope of the invention. Four wall boiler configurations are described in greater detail in commonly owned, co-pending U.S. patent application Ser. Nos. 12/547,650 and 12/617,054, filed Aug. 26, 2009 and Nov. 12, 2009, respectively, each of which is incorporated by reference herein in its entirety.

Referring now to FIG. 2, boiler 100 is further described in conjunction with a description of a construction sequence for boiler 100. FIG. 2 shows boiler 100 at a stage of construction where support structure 108 is in place on top of a receiver tower (not shown in FIG. 2 but see FIG. 1), prior to panels 104 (see FIG. 1) and drum 116 being mounted in place. Piping 118 is advantageously installed prior to raising drum 116 into place, since it is located above drum 116 in the finished construction.

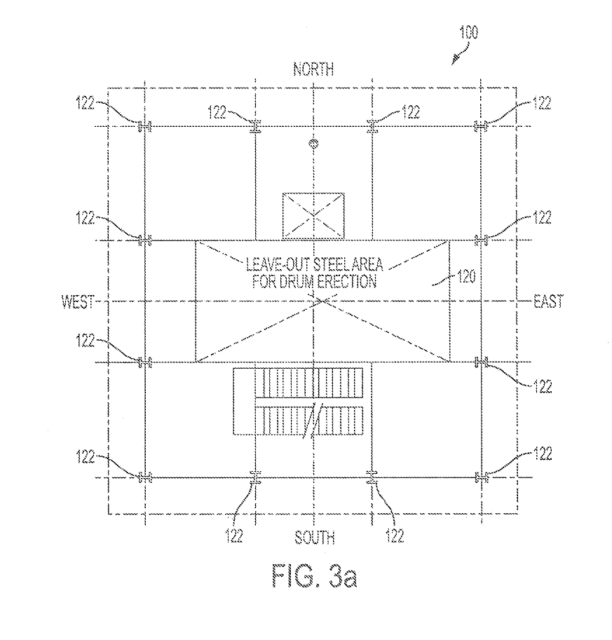

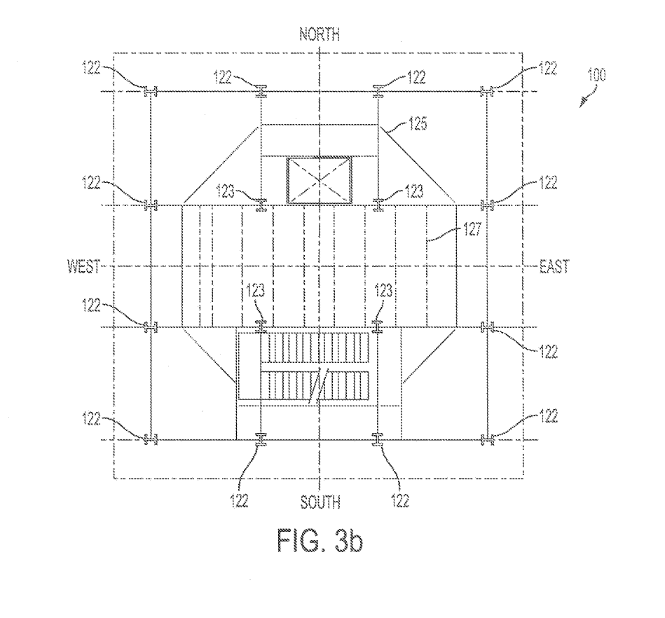

Support structure 108 includes vertical load bearing supports 122 arranged around a leave-out area 120 dimensioned to allow passage of drum 116 therethrough up from the base of boiler 100 (proximate the position of drum 116 in FIG. 2) to the final mounting position of drum 100 just below piping 118. FIG. 2 shows leave-out area 120 in dashed lines, and FIG. 3a shows leave-out area 120 in plan view. Leave-out area 120 is devoid of vertical load bearing supports 122 to accommodate passage of the drum therethrough during construction of the solar boiler.

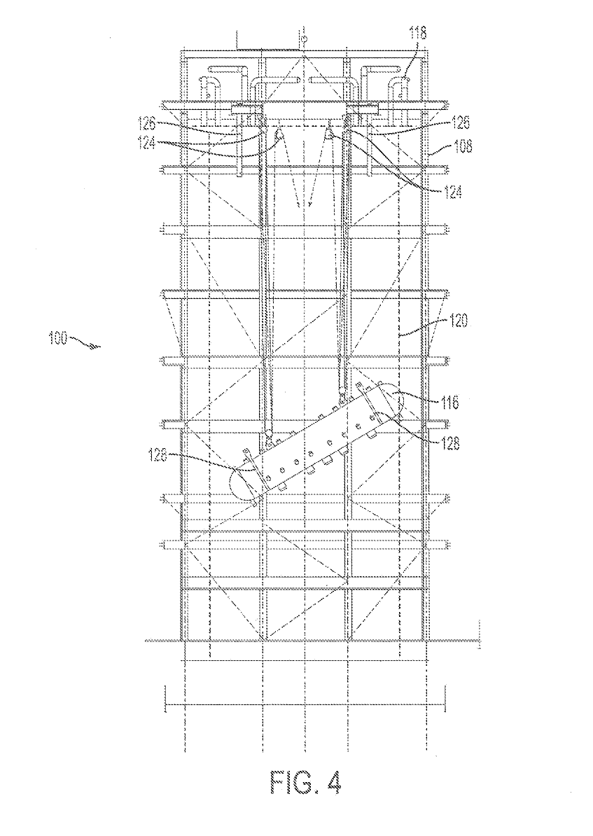

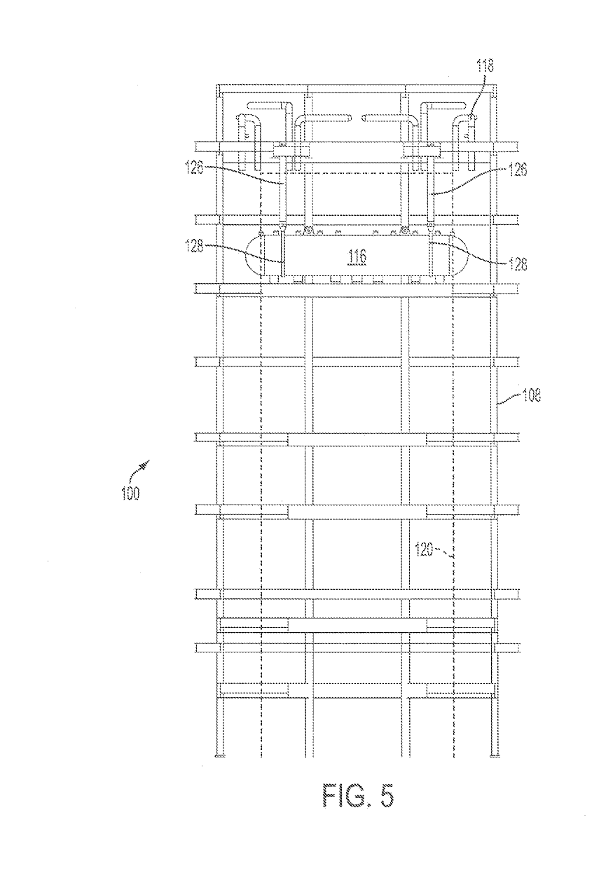

With continued reference to FIG. 2, block and tackle pulleys 124 mounted to support structure 108 can be used with a hoist (indicated by arrows in FIG. 2) to raise drum 116 upward through leave-out area 120, as indicated in FIG. 4, which shows drum 116 in transit through leave-out area 120. Drum 116 is hoisted on an angle to reduce its footprint during ascension as shown in FIGS. 2 and 4. Those skilled in the art will readily appreciate that this angled hoisting of drum 116 is optional but is advantageous for reducing the size of leave-out area 120. Upper drum straps 126 are mounted to support structure 108 near pulleys 124, and lower drum straps 128 are mounted to drum 116 prior to raising drum 116 through leave-out area 120. When drum 116 reaches the top of leave out area 120, it is leveled out and lower drum straps 128 are secured to upper drum straps 126, suspending the drum 116 within support structure 108 as shown in FIG. 5. Once drum straps 126, 128 are secured together, pulleys 124 can optionally be removed as well as any cables and hoists used in raising drum 116.

The same structure ultimately used to support drum 116 in the finished boiler 100 is thus used to support drum 116 during the hoisting process, eliminating the need for construction cranes and the like. In order to achieve this, however, the boiler and tower steel, i.e. support structure 108 and the structure of tower 102 shown in FIG. 1, have to be arranged to provide room in the structures, e.g. leave-out area 120 in the center of structure 108, to hoist the drum through the center, while still being rigid enough to support the weight of drum 116 and support structure 108. Support structure 108 is configured to be able to carry the load of the structure itself and all installed piping, headers, etc., as well as the weight of drum 116 without the benefit of support structure in leave-out area 120 while drum 116 is hoisted into position.

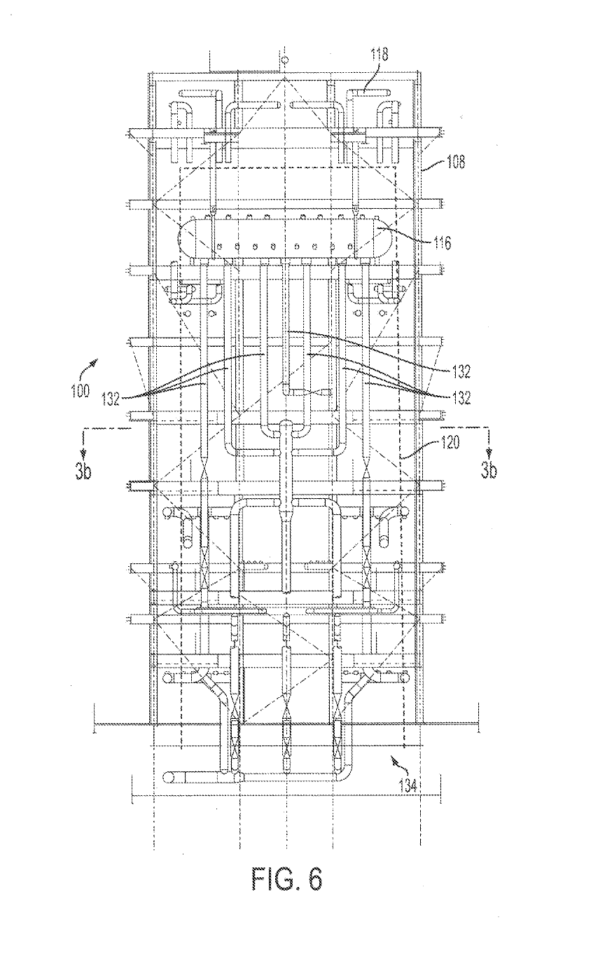

With reference now to FIGS. 6 and 3b, after hoisting drum 116 into its final location, the “leave-out” steel, or secondary structure, can be added in leave-out area 120 below drum 116. As shown in FIG. 3b, the leave-out steel installed after hoisting the drum into place includes vertical load bearing supports 123, and platform framing steel 127. Platform framing steel 125 can be installed before or after raising the drum through leave-out area 120 shown in FIG. 3a. Once all the steel is in place, the balance of the piping, headers, and any other applicable structures, supported by the “leave-out” steel can be added into boiler 100. Lower pipes 132 are shown in FIG. 6 connected to drum 116, support structure 108, and the leave out steal. Lower pipes 132 include the feedwater distribution pipes extending through leave-out area 120 from a pumping section 134 to drum 116. Access platforms, stairs, and related structures can be added in and around leave-out area 120 as indicated in FIGS. 3a and 3b. Insulation and/or lagging can be affixed to drum 116, and any piping and headers as needed.

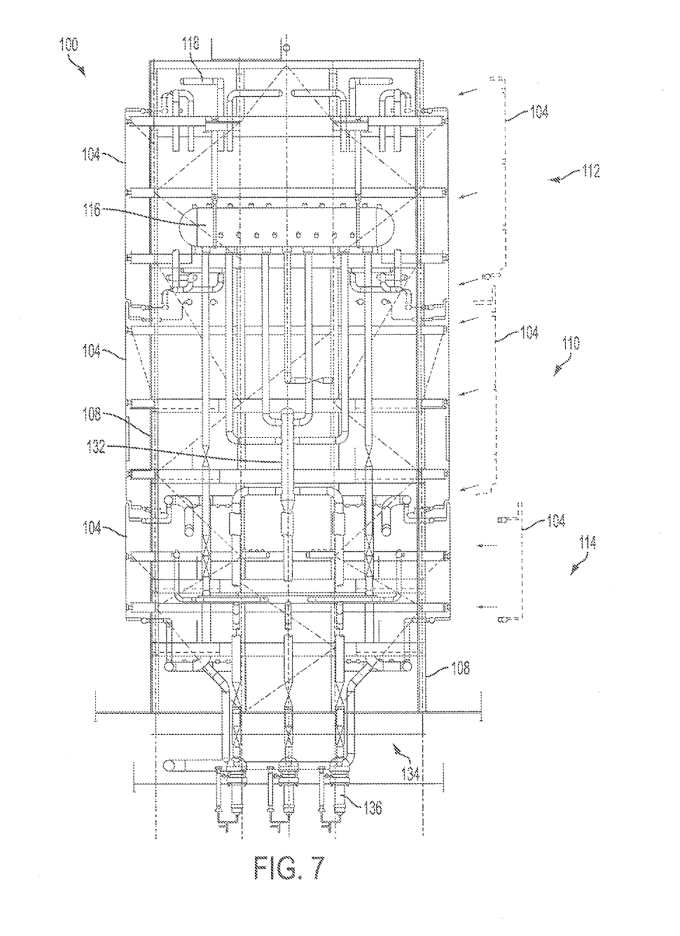

With reference now to FIG. 7 solar boiler panels 104 can be mounted to the support structure 108 to form an exterior heat transfer surface substantially surrounding a boiler interior space, as described above. Pumps 136 are connected to the feedwater distribution piping in pumping section 134. With solar boiler panels 104 and pumps 136 connected in fluid communication with drum 116, solar boiler 100 can be completed resulting in a boiler structure wherein the exterior heat transfer surface has an upper extent above drum 116 to shield drum 116 and boiler interior space 106 from concentrated solar radiation, as described above with reference to FIG. 1.

In summary, an exemplary construction sequence in accordance with the invention is as follows: install a receiver tower, install a receiver support structure, install piping located above the drum rigging, install drum straps and drum rigging, raise the drum through the receiver tower and support structure, level and pin the drum on elevation, install “leave-out” steel and platforms below the drum, install piping located below the drum elevation, and install piping/drum insulation and lagging.

The invention also provides a drum for a solar boiler. The drum includes drum internals (chevrons, steam separators), a chemical feed line, a blowdown line, downcomers, and feedwater distribution pipes. The steam drum includes an outer shell with hemispherical drumheads having an access way for maintenance. The drum contains internal chevrons and steam separators which separate and dry the saturated steam from the saturated water. The drum also contains a blowdown line to maintain water quality, downcomers to return saturated water to the steam generating panels, and releasers to return the now saturated steam to the drum. Also internal to the drum are feedwater distribution pipes, which allow entrance and adequate mixing of feedwater to the drum, and a chemical feed line.

A solar boiler constructed as described above has the steam drum located internal to the structure, as opposed to being located outside or above the structure itself. An internally located drum has several benefits including: reducing piping length, reduced heavy structural steel, and a lower center of gravity. Reducing piping length not only reduces the initial cost of a boiler, but also decreases the amount of pressure drop within the system, which can reduce parasitic loads as well as design and operating pressures. By positioning the drum within the support structure, steel, or other support materials, that are already in place to support other panels, piping, and headers can be used to hang the drum. This reduces the amount of steel, or other structural materials, required since additional heavy steel does not need to be placed above the structure. An internally located drum also lowers the center of gravity of the boiler, which is key in earthquake prone areas. An internally mounted steam drum also provides a pendulum dampening effect for earthquake and wind resistance when hung inside the respective solar boiler. Another benefit of locating a steam drum within a solar boiler structure is that the drum is protected from the intense solar radiation, since it is shaded from the heliostats by the heat transfer surfaces of the boiler panels. The steam drum therefore does not require additional thermal protection or radiation shielding.

Having the drum internally located within the structure solves the problem of lifting the heaviest component of a boiler over the top of the structure, which can be several hundred feet up in the air. Instead, the drum can be hoisted by the drum straps through the center of the boiler itself, using the boiler structure itself to bear the load. Using existing structure to hoist the drum upward eliminates the need for construction cranes when raising a steam drum into position, and also therefore allows for increased drum size and power production capacity compared to traditional solar boilers.

While described above in the exemplary context of steel, those skilled in the art will readily appreciate that any suitable materials can be used in the structures described above without departing from the spirit and scope of the invention. While leave-out area 120 has been described as being centered within boiler 100, those skilled in the art will readily appreciate that off-center leave-out areas can also be used without departing from the spirit and scope of the invention. Moreover, while described above in the exemplary context of a three-stage boiler, those skilled in the art will readily appreciate that any suitable boiler configuration or number of stages can be used without departing from the spirit and scope of the invention. The exemplary embodiments explained above have been described in the exemplary context of a steam drum. Those skilled in the art will readily appreciate that in addition to or in lieu of a steam drum, any other suitable steam/water vessel can be used. For example, in applications where a supercritical steam generator is used rather than a boiler type steam generator, a supercritical steam separator can be used as the steam/water vessel without departing from the scope of the invention. Moreover, as used herein, the term boiler is contemplated as descriptive of both sub-critical and supercritical systems and components, even for applications where there is no literal boiling.

The methods and systems of the present invention, as described above and shown in the drawings, provide for solar boilers and construction techniques with superior properties including eliminating the need for construction cranes, allowing for larger boilers and production capacities, and improved structural integrity for earthquake and wind loading resistance. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. A method of constructing a solar boiler comprising:
a) raising a steam/water vessel through a leave-out area in a boiler support structure; and
b) mounting the steam/water vessel within the boiler support structure below an upper extent of the boiler support structure.

2. A method of constructing a solar boiler as recited in claim 1, wherein the step of mounting the steam/water vessel within the boiler includes suspending the boiler within the support structure with straps.

3. A method of constructing a solar boiler as recited in claim 1, further comprising the step of installing piping to be located above the steam/water vessel, wherein the step of installing piping to be located above the steam/water vessel is performed prior to the step of raising the steam/water vessel.

4. A method of constructing a solar boiler as recited in claim 1, further comprising the step of installing secondary support structure in the leave-out area below the steam/water vessel.

5. A method of constructing a solar boiler as recited in claim 4, further comprising mounting piping below the steam/water vessel to the secondary support structure in the leave-out area.

6. A method of constructing a solar boiler as recited in claim 1, further comprising the step of installing steam/water vessel insulation and lagging on the steam/water vessel.

7. A method of constructing a solar boiler as recited in claim 1, further comprising the step of mounting a plurality of solar boiler panels to the support structure to form an exterior heat transfer surface substantially surrounding a boiler interior space, wherein the solar boiler panels are in fluid communication with the steam/water vessel, and wherein the exterior heat transfer surface has an upper extent above the steam/water vessel to shield the steam/water vessel and boiler interior space from concentrated solar radiation.
